(19) United States
(12) Patent Application Publication
(10) Pub. No.: US 2024/0157564 A1
(43) Pub. Date: May 16, 2024

(54) UNMANNED FULLY AUTONOMOUS VENDING KIOSK

(71) Applicant: PT INTERMEDIATE HOLDINGS IV, LLC, Addison, IL (US)

(72) Inventor: Robert Patrick Ritacco, Truro (CA)

(21) Appl. No.: 18/388,634

(22) Filed: Nov. 10, 2023

Related U.S. Application Data
(60) Provisional application No. 63/424,157, filed on Nov. 10, 2022.

(51) Int. Cl. B25J 9/16; G06Q 10/087; G06Q 30/0601; G07F 11/00; G07F 11/04

(52) U.S. Cl. CPC B25J 9/1697; G06Q 10/087; G06Q 30/0635; G07F 11/004; G07F 11/04; G06K 7/1417

(57) ABSTRACT

The invention is an unmanned kiosk configured to vend goods to consumers, accept and process returned goods from consumers, and replenish goods stored therein in fully autonomous manner.

### CROSS-REFERENCE TO RELATED APPLICATIONS

This application claims priority to, and the benefit of, U.S. Provisional Application No. 63/424,157, filed Nov. 10, 2022, the content of which is incorporated by reference herein in its entirety.

### TECHNICAL FIELD

The invention generally relates to consumer goods distribution techniques and systems, and, more particularly, to a system for providing a network of unmanned kiosks configured to vend goods to consumers, accept and process returned goods from consumers, and replenish goods stored therein in fully autonomous manner.

### BACKGROUND

Traditionally, vending machines were used for dispensing beverage cans, bottles, snacks, or other small durable products. While kiosks still exist for small items, larger kiosks are being implemented for larger items, such that customers can order products online, then pick them up at the kiosk. In some cases, the customer can order the item directly at the kiosk, and the kiosk can immediately deliver the product to the customer.

While vending machines have become more convenient due to their ability to make more products available, particularly with the ability to dispense or store online-ordered products, vending machines still have drawbacks. For example, one of the problems associated with conventional automated vending machines or kiosks is the difficulty associated with handling the various products stored within and replenishing such products. In particular, for a typical vending machine, an individual must manually refill and/or replace certain goods in the designated dispensing portions of the vending machine, which can be time consuming, costly and highly inefficient.

### SUMMARY

The present invention is directed generally to a goods distribution system that includes a plurality of unmanned fully autonomous vending kiosks. In particular, the goods distribution system provides an internet-based asset management platform, in which consumers can browse and purchase goods, such as by way of software application running on their mobile device (i.e., smartphone or the like). Upon purchasing a good, the asset management platform is configured to identify one or more of plurality of vending kiosks that have the particular purchased good available for the consumer to physically pick up. In other words, the asset management service is configured to identify one or more kiosks within a given location relative to the consumer (and further having said purchased good in stock) and further provide the consumer with the option of picking the purchased good at a given kiosk. In the event that the consumer selects a particular kiosk, the consumer is provided with a unique machine-readable code, such as a QR code, that they will subsequently use at the kiosk to show proof of purchase. The QR code will be associated with the transaction and thus will be tied to the particular good that was purchased.

The automated vending kiosks of the present invention are fully autonomous in that a given kiosk does not require any form of human intervention when vending goods to consumers, accepting returns for and automatically restocking returned goods, and further accepting and automatically replenishing goods to be vended.

In particular, a vending kiosk consistent with the present disclosure is a standalone structure that includes an overall enclosure and provides an interior for housing the various components involved in a given transaction. For example, the kiosk may include a drive-thru configuration in which the structure includes a defined window or port with which a user interacts when picking up a purchased good, returning a good, and when additional goods are provided for replenishing inventory stored within the kiosk. The window or port may include some form of user interface with which a person can interact from their vehicle or on foot, such as a display providing a graphical user interface (GUI) allowing a person to present a QR code, for example, which is scanned (via an integrated scanning module associated with the user interface of the kiosk) thereby setting the particular transaction in motion.

Upon scanning the QR code, a determination is made as to whether the QR code is valid (i.e., whether it matches with a QR code generated and sent to the consumer). In other words, the kiosk may generally include a computing system configured to communicate and exchange data with the asset management platform. As such, upon scanning the QR code presented by the consumer, the QR code data is processed to determine whether there is a positive correlation with a reference QR, thereby indicating that the presented QR code is valid. In turn, the kiosk computing system is configured to then communicate with various internal components tasked with accessing and subsequently vending the purchased good associated with the QR code to the consumer.

For example, the kiosk may include a tower structure within the enclosure that is configured to hold a plurality of goods upon a plurality of organized shelves. For example, in one embodiment, the tower may include a plurality of vertically arranged shelving, such that the inventory is provided within respective trays provided on the shelves in a substantially vertically stacked arrangement. Each shelf may support one or more compartmentalized trays, for example, in which specific goods are placed within specific compartments of a given tray and such organization is saved in a database. In other words, each good, each compartment in a given tray, each tray, as well as each shelf of the tower, may have a unique identification code or the like that is associated therewith, such that a given good has a defined compartment within a defined tray, to be placed upon a defined shelf.

It should be noted that the goods distribution system is further configured to provide tray and/or shelf packing optimization. In particular, the system is able to utilize packing algorithms to identify optimal packing arrangements for a given tray and/or shelf. For example, in one embodiment, any given tray and/or shelf may be analyzed and subsequently packed with goods in an optimal arrangement so as to fully utilize the capacity of the given tray and/or shelf as well as provide the most highly requested, purchased, or otherwise sought after goods. The optimal packing can be accomplished based on an analysis of a given tray and/or shelf include utilizing the known volume of a given tray or shelf, as well as the known volume and/or packaging dimensions of goods, and arranging placement of a set of goods into the tray or shelf in such a manner that nearly all usable volume of a given tray or shelf is utilized.

In turn, any given good within the tower has a known exact location based on an association of the unique identification codes to thereby allow for recognition and subsequent movement (i.e., vending, replenishing, etc.) of a given good. It should be noted that, in some embodiments, trays, shelving, and/or goods may be radio-frequency identification (RFID) enabled to allow for recognition and subsequent movement (i.e., vending, replenishing, etc.) of a given good.

The tower essentially encloses a mechanized storage and retrieval assembly configured to access trays within the tower for vending and replenishment functions. For example, the kiosk may include a vertical lift module, a vertical carousel module, or the like for providing automated storage and retrieval of goods within the tower. Accordingly, the storage and retrieval assembly may allow for access to any given good based on the known location thereof. For example, upon analyzing the QR code, the specific good is identified, which, in turn, causes mechanized storage and retrieval assembly obtain a tray upon which a specific good is placed.

The kiosk further comprises an anthropomorphic robotic arm configured to pick the specific good from the tray and present the good to the consumer via the drive-thru port. In particular, the anthropomorphic robotic arm utilizes vision-based grasping techniques to identify the good, grasp the good (without causing damage to the good), and position the good at the port, allowing for the consumer to receive the good and complete the transaction.

It should be noted that the port generally includes at least a two closures, including an outer closure and in inner closure, each of which is configured to move between fully opened and fully closed positions. For example, the default position of both the outer closure and the inner closure is in a closed position. Accordingly, upon initiating an order pickup transaction (in which a good is being vended to a consumer), the outer and inner closures remain closed until the specific good has been retrieved by the internal mechanism within the kiosk. Upon the robotic arm picking the specific good from the retrieved tray, the inner closure may open while the outer closure remains closed, which exposes a space defined between the outer and inner closures and into which the robotic arm can place the good. Upon placing the good within that space, the inner closure closes, thereby sealing off the interior of the kiosk and the outer closure opens, thereby presenting the good to the consumer.

In the event that a consumer is returning a good, the kiosk is configured to operate generally in a similar manner as when a good is being vended to the consumer (i.e., when a good is ordered and being picked up). For example, the consumer may initiate the return of a good via the internet-based asset management platform. Again, the asset management platform is configured to identify one or more of plurality of vending kiosks with a given location relative to the consumer and further provide the consumer with the option of traveling to and returning the particular good a given kiosk. In the event that the consumer selects a particular kiosk, the consumer is provided with a unique machine-readable code (e.g., QR code) that they will subsequently use at the kiosk to show proof of return (the QR code will be associated with the return and thus will be tied to the particular good that is to be returned).

Again, upon scanning the QR code, a determination is made as to whether the QR code is valid (i.e., whether it matches with a QR code generated and sent to the consumer). Upon establishing that the QR code is valid, the kiosk computing system is configured to then communicate with various internal components tasked with accepting the returned good and either placing the returned good back into the internal inventory of the kiosk or placing the returned good into a separate container (i.e., a tote or the like) to be subsequently retrieved and transported to a distribution center or the like. In particular, upon scanning the QR code, the outer closure will open (while the inner closure remains closed) thereby prompting the consumer to place the returned good within the space defined between the inner and outer closures if the port. The kiosk computing system will recognize that a good has been placed within the port, and will thus cause the outer closure to close and the inner closure to open. Accordingly, based on the data associated with the scanned QR code, the internal components will automatically go into action. In particular, the anthropomorphic robotic arm will retrieve the good and, in the event that the returned good is to be restocked in the inventory, the vertical lift module will automatically retrieve a tray to which the returned good is to be placed (via the robotic arm).

In addition to vending goods and accepting returned goods, the kiosk of the present invention is configured to automatically replenish inventory in an autonomous manner. More specifically, the kiosk is configured to essentially restock the inventory in a fully automated manner and without requiring human intervention. For example, the specific inventory of any given kiosk can be managed by the asset management platform. It may be determined at any given time that certain goods need to be replenished (i.e., the number of available goods is low in a given kiosk's inventory tower). As such, goods can be delivered to the kiosk via conventional means, such as by way of a vehicle. The driver of the vehicle need only interact with the drive-thru port interface (i.e., present a QR code associated with the replenishing goods) and then provide such goods to the kiosk. The goods may be provided in a large container, such as a tote or the like. Upon placing the tote within the port, the internal components of the kiosk take over, in that the robotic arm is configured to pick goods from the tote and place them into assigned compartments of trays that are placed onto the associated shelves of the tower via the vertical lift module.

It should further be noted that, in addition to providing automated vending and storage services, the network of kiosks may also be utilized to provide advertising services. In particular, the exterior of a given kiosk may include one or more digital displays for providing advertisements to the general public.

Accordingly, the unmanned fully autonomous vending kiosks of the present invention provide numerous advantages over current vending options. In particular, the kiosks are configured to cooperatively function with an internet-based asset management service that allows consumers browse and purchase various goods and further initiate a pickup or return of a purchased good via a given one of the network of kiosks. Each kiosk is configured to vend purchased goods to consumers, accept and process returned goods from consumers, and further replenish goods stored therein in fully autonomous manner and without requiring human intervention.

### BRIEF DESCRIPTION OF THE DRAWINGS

FIG. 1 is a block diagram illustrating one embodiment of an exemplary system for providing consumers with access to a network of unmanned kiosks configured to vend goods to consumers, accept and process returned goods from consumers, and replenish goods stored therein in fully autonomous manner.

FIG. 2 is a block diagram illustrating the asset management platform of FIG. 1 in greater detail.

FIG. 3 is a block diagram illustrating at least one embodiment of a computing device (i.e., mobile device) for communicating with the asset management platform and providing an interface upon which the user can interact so as browse and either purchase goods or initiate a process for returning purchased goods and utilizing a selected one of the network of kiosks for either vending a purchased good or accepting a return of a good.

FIG. 4 is a block diagram illustrating communication and exchange of data between a mobile device of a consumer, the asset management platform, the autonomous vending kiosks consistent with the present disclosure.

FIG. 5 is a perspective view of an exterior of a kiosk consistent with the present disclosure.

FIGS. 6A-6J illustrate a first scenario consisting of a consumer ordering a part via interaction with the asset management platform and subsequent vending of that part via from the autonomous vending kiosk.

FIG. 6A is a screenshot of an interface on a mobile device associated with the asset management services provided by the asset management platform of the present disclosure.

FIG. 6B depicts the consumer arriving at the kiosk and interacting with a self-service vending port of the kiosk.

FIG. 6C is a screenshot of QR code that the consumer was provided upon purchasing a good, wherein such QR code is presented to the user interface at the vending port of the kiosk to initiate a vending transaction.

FIGS. 6D and 6E are perspective views of an interior portion of the kiosk, illustrating various internal components for carrying out automated vending, return, and replenishment functions without requiring human intervention.

FIGS. 6F and 6G depict automatic retrieval, via a vertical lift module, of a tray from the inventory tower that contains a purchased good to be vended to the consumer.

FIGS. 6H and 6I depict picking of the purchased good from the retrieved tray via an anthropomorphic robotic arm.

FIG. 6J depicts presentation of the purchased good to the consumer via the self-service vending port of the kiosk.

FIGS. 7A-7F illustrate a second scenario consisting of replenishing inventory of the autonomous vending kiosk.

FIG. 7A depicts a delivery driver arriving at the kiosk and interacting with a self-service port of the kiosk.

FIG. 7B is a screenshot of QR code that the delivery driver can present to the user interface at the port of the kiosk to initiate a replenishment transaction.

FIG. 7C depicts delivery of parts (i.e., placement of the parts within the port of the kiosk) that are to be subsequently stocked in the kiosk's inventory.

FIG. 7D depicts automatic retrieval of the delivered parts from the port via the anthropomorphic robotic arm.

FIGS. 7E and 7F depict automatic restocking of the delivered parts to the inventory via actions carried out by the anthropomorphic robotic arm and vertical lifting module.

FIG. 8 is a perspective view of an exterior of a kiosk consistent with the present disclosure including digital displays.

FIG. 9 is an image depicting placement of a kiosk within retail location and having a digital display for advertisements.

FIG. 10 is a perspective view of shelving and various goods to be arranged on such shelving to achieve optimal packing arrangements.

FIGS. 11A and 11B illustrate exemplary embodiments of shelves packed with various goods in an optimal arrangement based on packing algorithms.

### DETAILED DESCRIPTION

By way of overview, the present invention is directed to vending kiosks configured to vend goods to consumers, accept and process returned goods from consumers, and replenish goods stored therein in fully autonomous manner.

More specifically, the vending kiosks of the present invention are included in a broader distribution system that includes an internet-based asset management platform, in which consumers can browse and purchase goods by way of software application running on their mobile device (i.e., smartphone or the like). In particular, the asset management system generally provides a consumer with access to various repairs parts for specific home-related products that they own, such as appliances, tools, and the like.

Accordingly, consumers are able to find repair parts for their specific products when a breakdown occurs and purchase such parts through the app. Furthermore, rather than having to wait for a part to be shipped, or travel to a traditional brick and mortar store and search through aisles in hopes of finding the correct repair part, thereby potentially delaying the time until a repair can be made, the consumer is able to elect to subsequently pick up the purchased parts at a nearby kiosk identified in the app. Consumers can also initiate a return of a part via the app and thus are able to elect to return the part at a nearby kiosk. As such, the present invention, namely the combination of the network of unmanned kiosks and the internet-based asset management platform offers consumers a convenient, easy, and inexpensive solution for getting the right part and in a highly convenient manner. The present invention further addresses the consumer's need for a broad number of parts to support the wide range of assets that the consumer owns, which is not fully addressed in today's market. For example, traditional big box stores carry only a few generic parts, while specialty stores may not be located within convenient retail locations. The system of the present invention addresses these noted drawbacks.

As will be described in greater detail herein, the automated vending kiosks of the present invention are fully autonomous in that a given kiosk does not require any form of human intervention when vending goods to consumers, accepting returns for and automatically restocking returned goods, and further accepting and automatically replenishing goods to be vended. Accordingly, the unmanned fully autonomous vending kiosks of the present invention provide numerous advantages over current vending options. In particular, the kiosks are configured to cooperatively function with an internet-based asset management service that allows consumers browse and purchase various goods and further initiate a pickup or return of a purchased good via a given one of the network of kiosks. Each kiosk is configured to vend purchased goods to consumers, accept and process returned goods from consumers, and further replenish goods stored therein in fully autonomous manner and without requiring human intervention.

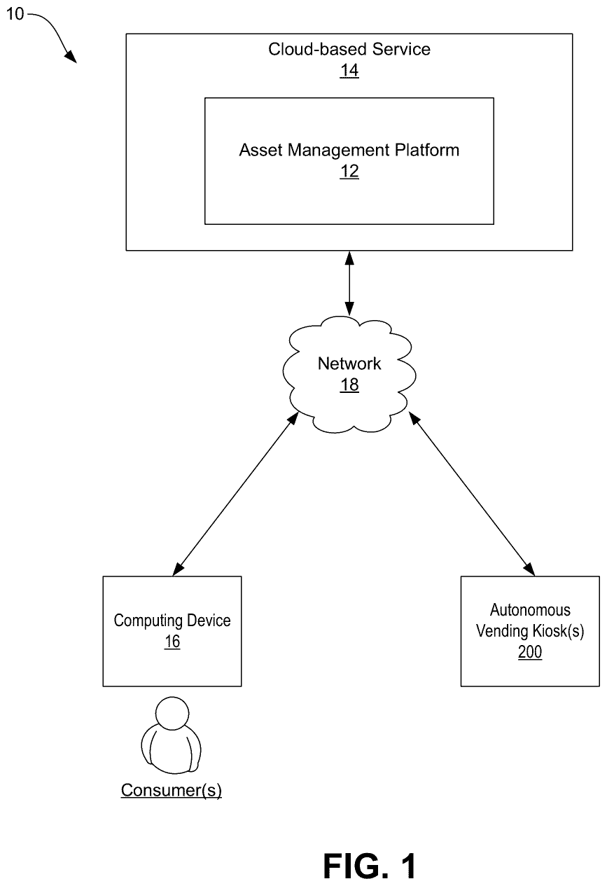

FIG. 1 is a block diagram illustrating one embodiment of an exemplary system 10 for providing consumers with access to a network of unmanned kiosks configured to vend goods to consumers, accept and process returned goods from consumers, and replenish goods stored therein in fully autonomous manner. As shown, system 10 includes an asset management platform 12 embodied on an internet-based computing system/service. For example, as shown, the asset management platform 12 may be embodied on a cloud-based service 14, for example. The asset management platform 12 is configured to communicate and share data, specifically home assets, such as appliances, tools, and the like, as well as repair products, including parts, for such home assets, to users (i.e., consumers) via a computing device 16 over a network 18, for example. For example, the asset management platform 12 may generally be embodied in a similar manner, function in a similar manner, and provide similar information as the asset management systems and methods described in U.S. Patent Publication No. 2016/0357876 titled “Asset Communication Hub”, the content of which is incorporated herein by reference in its entirety. It should be further noted that the system 10 further includes a plurality of autonomous vending kiosks 200 configured to communicate and share data with the asset management platform and the consumers via the computing device 16 of the network.

The network 18 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the computing devices 16 and/or between the computing devices 16 and the cloud-based service 14, may be, in whole or in part, a wired connection.

The network 18 may be any network that carries data. Non-limiting examples of suitable networks that may be used as network 18 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), the most recently published versions of IEEE 802.11 transmission protocol standards, other networks capable of carrying data, and combinations thereof. In some embodiments, network 18 is chosen from the internet, at least one wireless network, at least one cellular telephone network, and combinations thereof. As such, the network 18 may include any number of additional devices, such as additional computers, routers, and switches, to facilitate communications. In some embodiments, the network 18 may be or include a single network, and in other embodiments the network 18 may be or include a collection of networks.

The asset management platform 12 is configured to communicate and share data with computing devices 16 associated with a consumer. Accordingly, the computing device 16 may be embodied as any type of device for communicating with the asset management platform 12 and cloud-based service 14, and/or other user devices over the network 18. For example, the computing device may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure. In the embodiments described here, the computing device 16 is generally embodied as a smartphone or tablet. However, it should be noted that one or more devices 16 may include a computer, a desktop computer, a personal computer (PC), a tablet computer, a laptop computer, a notebook computer, and the like.

It should be noted that embodiments of the system 10 of the present disclosure include computer systems, computer operated methods, computer products, systems including computer-readable memory, systems including a processor and a tangible, non-transitory memory configured to communicate with the processor, the tangible, non-transitory memory having stored instructions that, in response to execution by the processor, cause the system to perform steps in accordance with the disclosed principles, systems including non-transitory computer-readable storage medium configured to store instructions that when executed cause a processor to follow a process in accordance with the disclosed principles, etc.

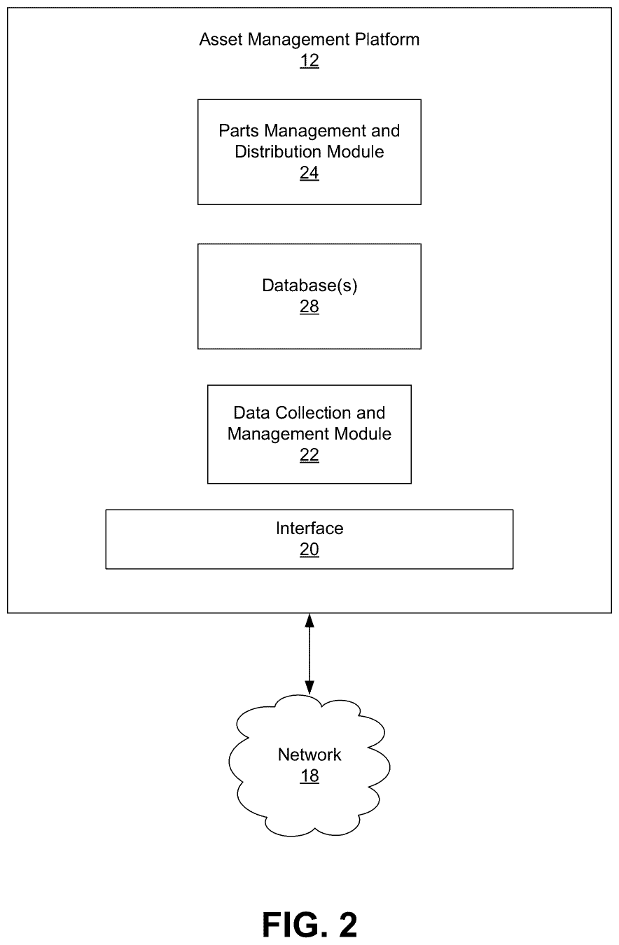

FIG. 2 is a block diagram illustrating the asset management platform 12 in greater detail. As shown, the asset management platform 12 may include an interface 20, a data collection and management module 22, a parts management and distribution module 24, and various databases 28 for storage of data. For example, the databases 28 may include databases for storage of content related to home assets, including, but not limited to, household appliances such as a dishwasher or a refrigerator, major home appliances and equipment such as HVAC systems or water heaters, home electronics such as a television or a stereo, home building materials such as flooring or paint, or even a tree or plant in or near a home. The content related to home assets may include user manuals, how-to videos, maintenance history, maintenance schedule, notes, purchase documents, warranty information, or any other content related to a home asset. The databases 28 may also include databases for storage of inventory records of a user, as well as databases for storage of client/user accounts, including any associated purchases, returns, and the like. The databases 28 may further include databases for storage of inventory data of the network of kiosks. In other words, the asset management platform 12 may be configured to generally monitor the status of a given kiosk, including monitoring all transactions associated therewith, as well as the inventory of stocked parts and further manage inventory replenishment, particularly via the parts management and distribution module 24. The data collection and management module 22 may be configured to communicate and exchange data with each of the databases.

The interface 20 may generally allow a consumer to access data on the asset management platform 12, via a mobile software application, for example, provided on a mobile device or via a web-based portal. For example, upon accessing a mobile software application, the interface 20 may be presented to the user via their device 16, in which the user may navigate a dashboard or standard platform interface so as to view data (stored in one or more of the databases) and to further initiate the purchase of a part and subsequent picking up of that purchases part at a kiosk or to initiate a return of a part to a given kiosk. The software application may be, for example, the Fix app offered by Fix.com, and thus a consumer can browse through various repair parts as desired via said app and purchase any available part.

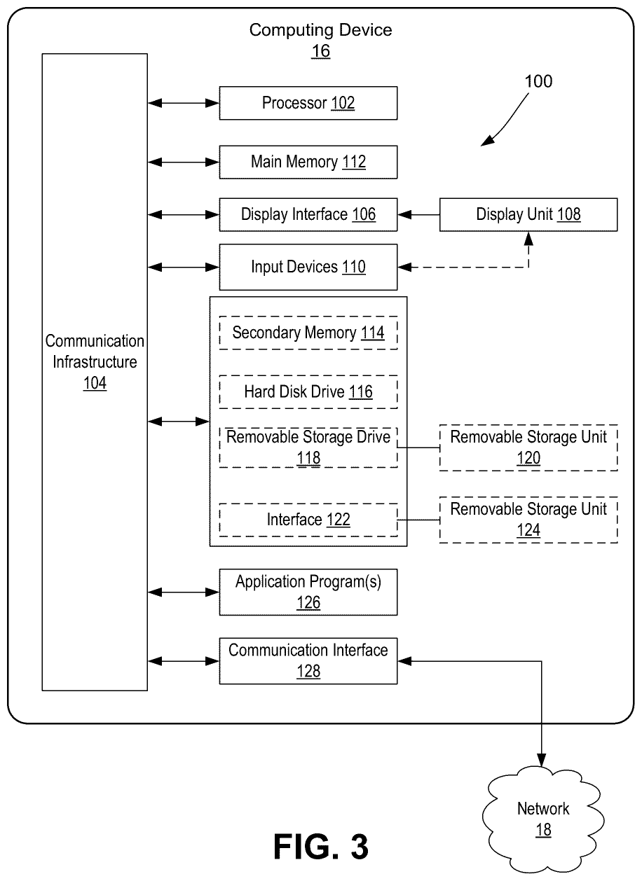

FIG. 3 is a block diagram illustrating at least one embodiment of a computing device 16 for communicating with the asset management platform 12 and providing an interface upon which the user can interact so as browse and either purchase goods or initiate a process for returning purchased goods and utilizing a selected one of the network of kiosks for either vending a purchased good or accepting a return of a good. As previously described herein, the computing device 16 may generally be a mobile device, such as a smartphone or tablet.

The computing device 16 generally includes a computing system 100. As shown, the computing system 100 includes one or more processors, such as processor 102. Processor 102 is operably connected to communication infrastructure 104 (e.g., a communications bus, cross-over bar, or network). The processor 102 may be embodied as any type of processor capable of performing the functions described herein. For example, the processor may be embodied as a single or multi-core processor(s), digital signal processor, microcontroller, or other processor or processing/controlling circuit.

The computing system 100 further includes a display interface 106 that forwards graphics, text, sounds, and other data from communication infrastructure 104 (or from a frame buffer not shown) for display on display unit 108. The computing system further includes input devices 110. The input devices 110 may include one or more devices for interacting with the computing device 16, such as a keypad, microphone, camera, as well as other input components, including motion sensors, and the like. In one embodiment, the display unit 108 may include a touch-sensitive display (also known as “touch screens” or “touchscreens”), in addition to, or as an alternative to, physical push-button keyboard or the like. The touch screen may generally display graphics and text, as well as provides a user interface (e.g., but not limited to graphical user interface (GUI)) through which a user may interact with the computing device 16, such as accessing and interacting with applications executed on the device 16, including an app for providing direct user input with asset management services offered by the asset management platform.

The computing system 100 further includes main memory 112, such as random access memory (RAM), and may also include secondary memory 114. The main memory 112 and secondary memory 114 may be embodied as any type of device or devices configured for short-term or long-term storage of data such as, for example, memory devices and circuits, memory cards, hard disk drives, solid-state drives, or other data storage devices. Similarly, the memory 112, 114 may be embodied as any type of volatile or non-volatile memory or data storage capable of performing the functions described herein.

In the illustrative embodiment, the computing device 16 may maintain one or more application programs, databases, media and/or other information in the main and/or secondary memory 112, 114. The secondary memory 114 may include, for example, a hard disk drive 116 and/or removable storage drive 118, representing a floppy disk drive, a magnetic tape drive, an optical disk drive, etc. Removable storage drive 118 reads from and/or writes to removable storage unit 120 in any known manner. The removable storage unit 120 may represents a floppy disk, magnetic tape, optical disk, etc. which is read by and written to by removable storage drive 118. As will be appreciated, removable storage unit 120 includes a computer usable storage medium having stored therein computer software and/or data.

In alternative embodiments, the secondary memory 114 may include other similar devices for allowing computer programs or other instructions to be loaded into the computing system 100. Such devices may include, for example, a removable storage unit 124 and interface 122. Examples of such may include a program cartridge and cartridge interface (such as that found in video game devices), a removable memory chip (such as an erasable programmable read only memory (EPROM), or programmable read only memory (PROM)) and associated socket, and other removable storage units 124 and interfaces 122, which allow software and data to be transferred from removable storage unit 124 to the computing system 100.

The computing system 100 further includes one or more application programs 126 directly stored thereon. The application program(s) 126 may include any number of different software application programs, each configured to execute a specific task.

The computing system 100 further includes a communications interface 128. The communications interface 128 may be embodied as any communication circuit, device, or collection thereof, capable of enabling communications between the computing device 16 external devices (e.g., the cloud-based service 14, including the asset management platform 12, as well as any given kiosk 200). The communications interface 128 may be configured to use any one or more communication technology and associated protocols, as described above, to effect such communication. For example, the communications interface 128 may be configured to communicate and exchange data with the asset management platform 12, and/or a given kiosk 200, via a wireless transmission protocol including, but not limited to, Bluetooth communication, infrared communication, near field communication (NFC), radio-frequency identification (RFID) communication, cellular network communication, the most recently published versions of IEEE 802.11 transmission protocol standards, and a combination thereof. Examples of communications interface 128 may include a modem, a network interface (such as an Ethernet card), a communications port, a Personal Computer Memory Card International Association (PCMCIA) slot and card, wireless communication circuitry, etc.

Computer programs (also referred to as computer control logic) may be stored in main memory 112 and/or secondary memory 114 or a local database on the computing device 16. Computer programs may also be received via communications interface 128. Such computer programs, when executed, enable the computing system 100 to perform the features of the present invention, as discussed herein. In particular, the computer programs, including application programs 126, when executed, enable processor 102 to perform the features of the present invention. Accordingly, such computer programs represent controllers of computer system 100.

In one embodiment where the invention is implemented using software, the software may be stored in a computer program product and loaded into the computing system 100 using removable storage drive 118, hard drive 116 or communications interface 128. The control logic (software), when executed by processor 102, causes processor 102 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

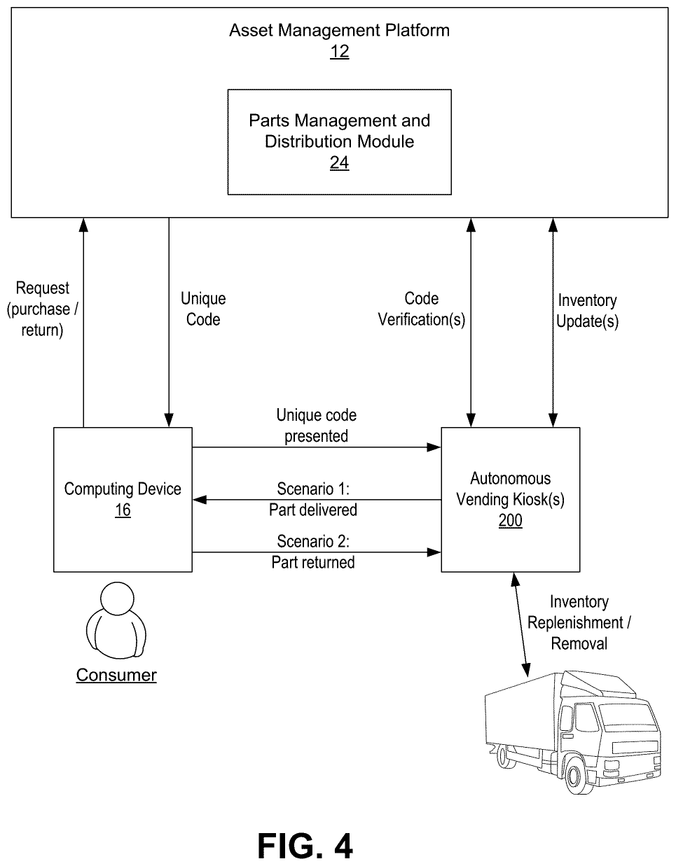

FIG. 4 is a block diagram illustrating communication and exchange of data between a computing device 16 of a consumer, the asset management platform 12, and the autonomous vending kiosks 200 consistent with the present disclosure. As previously described, a consumer may access the asset management platform via their computing device 16 (via a software application), and either purchase a part or request for a refund of a purchased part, thereby initiating a return. In turn, the request (i.e., the purchase or return request) is received by the asset management platform. In turn, the asset management platform 12 is configured to identify one or more of plurality of vending kiosks 200 that have the particular purchased part available for the consumer to physically pick up or for receiving the part to be returned. As previously described, the asset management platform 12 is able to (via the parts management and distribution module 24) monitor the status of a given kiosk, including monitoring all transactions associated therewith, as well as the inventory of stocked parts and further manage inventory replenishment. In other words, the platform 12 includes a database storing inventory data for any given kiosk 200. Accordingly, upon receiving a request for the purchase of a given part, the platform 12 is able to determine which specific kiosk(s) 200 from the network of kiosks has that given part available to be picked up.

A such, the asset management service is configured to identify one or more kiosks within a given location relative to the consumer (and further having said purchased part in stock) and further provide the consumer with the option of picking the purchased part at a given kiosk. In the event that the consumer selects a particular kiosk, the consumer is provided with a unique machine-readable code, such as a QR code, that they will subsequently use at the kiosk to show proof of purchase. The QR code will be associated with the transaction and thus will be tied to the particular part that was purchased.

Upon reaching the selected kiosk 200, the consumer is able to simply utilize a user interface associated with the kiosk (i.e., an interactive display allowing for a consumer to present their QR code. The QR code is scanned (via an integrated scanning module associated with the user interface of the kiosk) thereby setting the particular transaction in motion. Upon scanning the QR code, a determination is made as to whether the QR code is valid (i.e., whether it matches with a QR code generated and sent to the consumer). In other words, the kiosk 200 may generally include a computing system configured to communicate and exchange data with the asset management platform 12. As such, upon scanning the QR code presented by the consumer, the QR code data is processed to determine whether there is a positive correlation with a reference QR (i.e., a QR code that is saved and tied to the initial purchase transaction or return transaction), thereby indicating that the presented QR code is valid. In turn, the kiosk computing system is configured to then communicate with various internal components tasked with accessing and subsequently vending the purchased part associated with the QR code to the consumer or accepting the part to be returned.

In addition to vending parts and accepting returned parts, the kiosk 200 is configured to automatically replenish inventory in an autonomous manner. More specifically, the kiosk is configured to essentially restock the inventory in a fully automated manner and without requiring human intervention. For example, the specific inventory of any given kiosk can be managed by the asset management platform 12, specifically via the parts management and distribution module 24. It may be determined at any given time that certain parts need to be replenished (i.e., the number of available parts is low in a given kiosk's inventory). As such, the parts can be delivered to the kiosk via conventional means, such as by way of a vehicle.

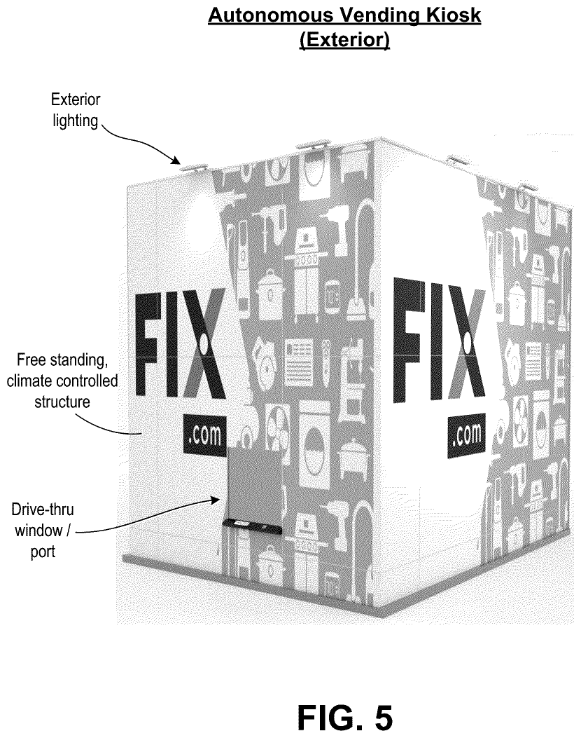

FIG. 5 is a perspective view of an exterior of a kiosk consistent with the present disclosure. As shown, the vending kiosk is a standalone structure that includes an overall enclosure and provides an interior for housing the various components involved in a given transaction. The kiosk may include a drive-thru configuration in which the structure includes a defined window or port with which a user interacts when picking up a purchased part, returning a part, or when additional parts are provided for replenishing inventory stored within the kiosk. The window or port may include some form of user interface with which a person can interact from their vehicle or on foot, such as a display providing a graphical user interface (GUI) allowing a person to present a QR code, for example, which is scanned (via an integrated scanning module associated with the user interface of the kiosk) thereby setting the particular transaction in motion.

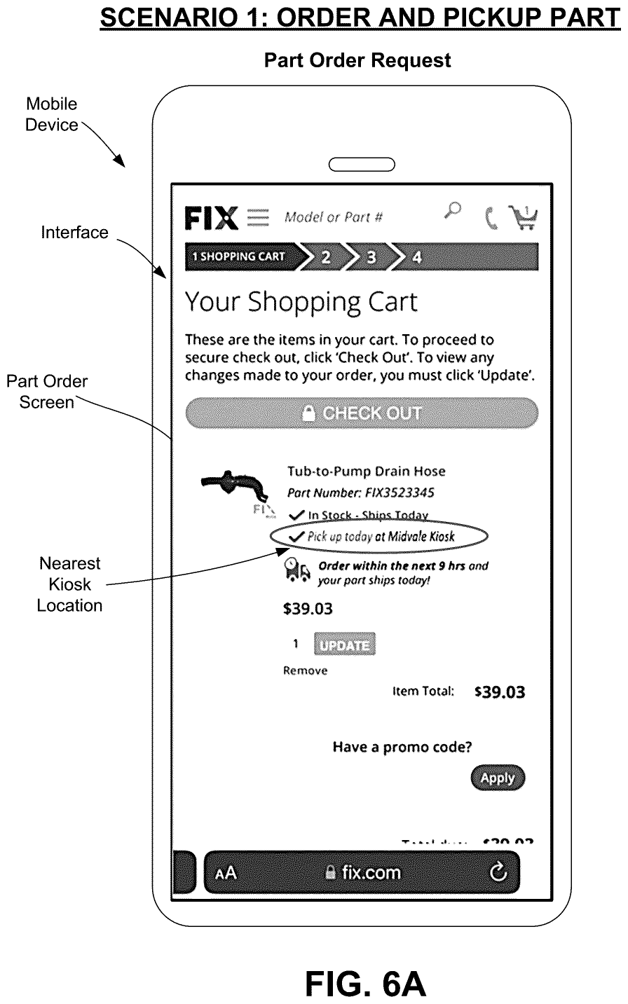

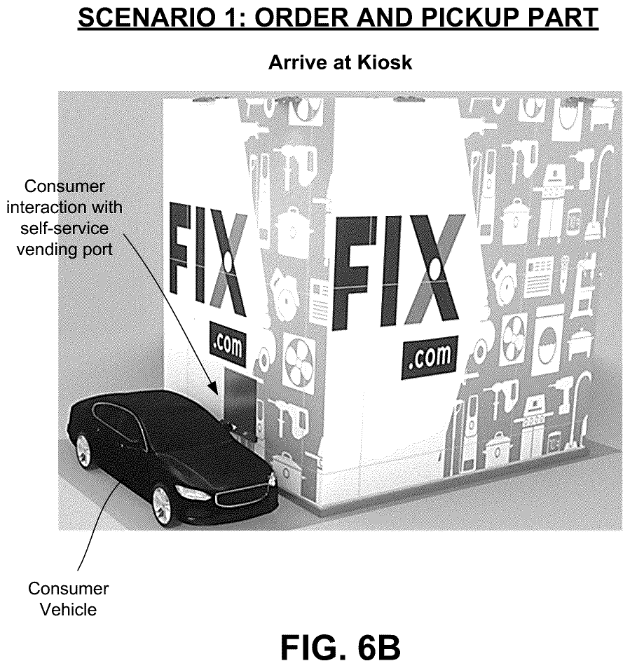

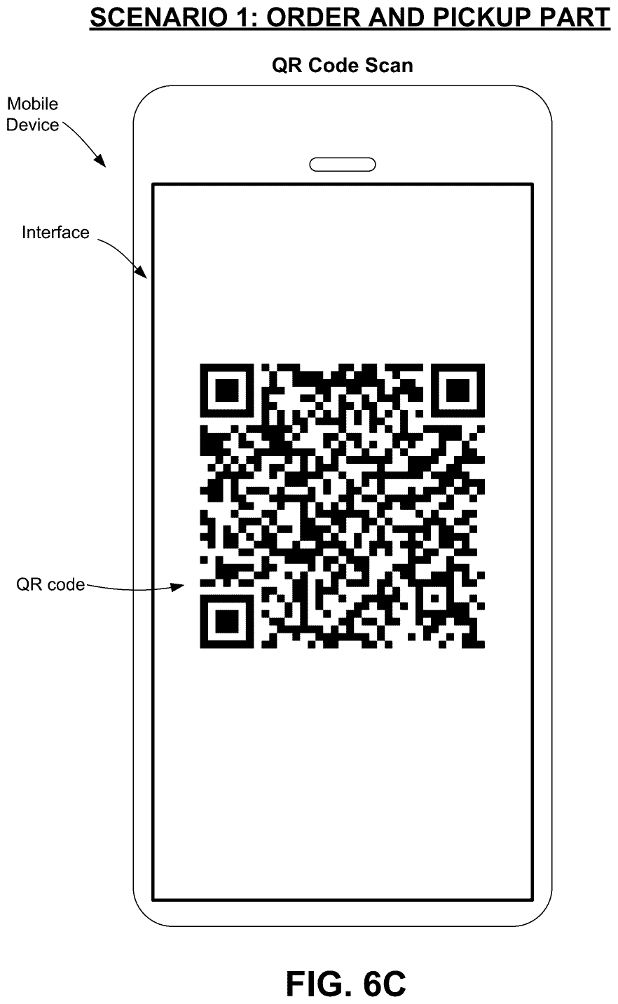

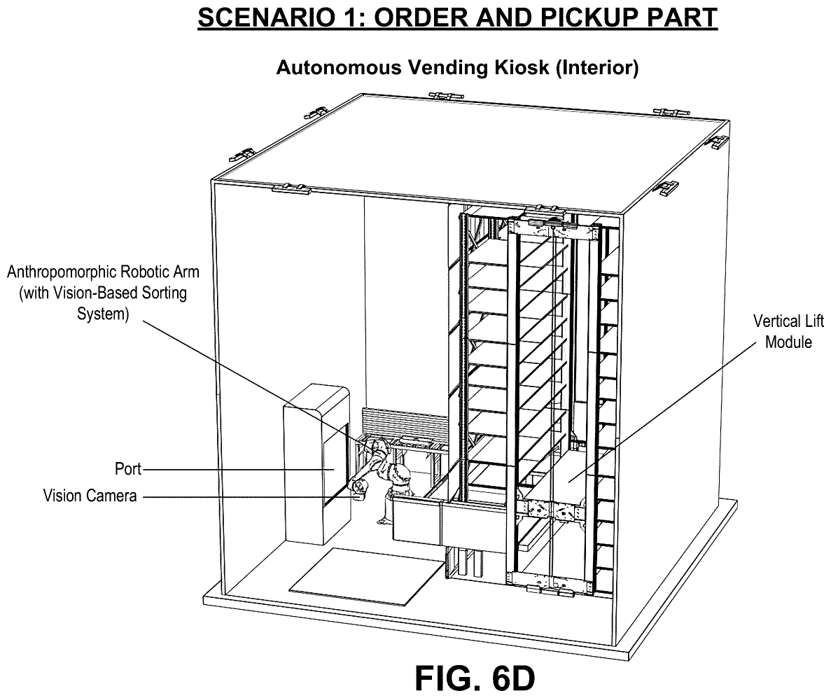

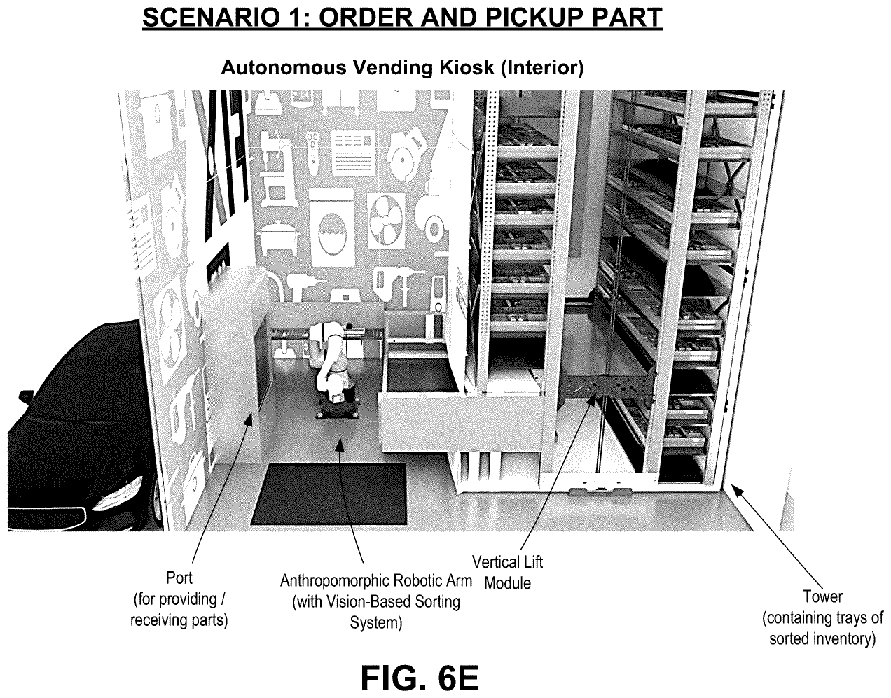

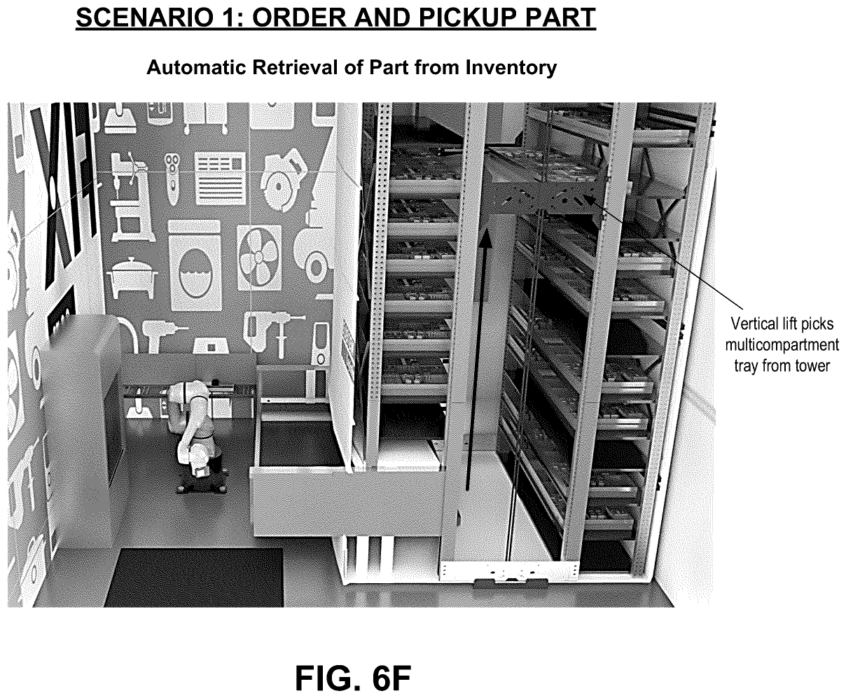

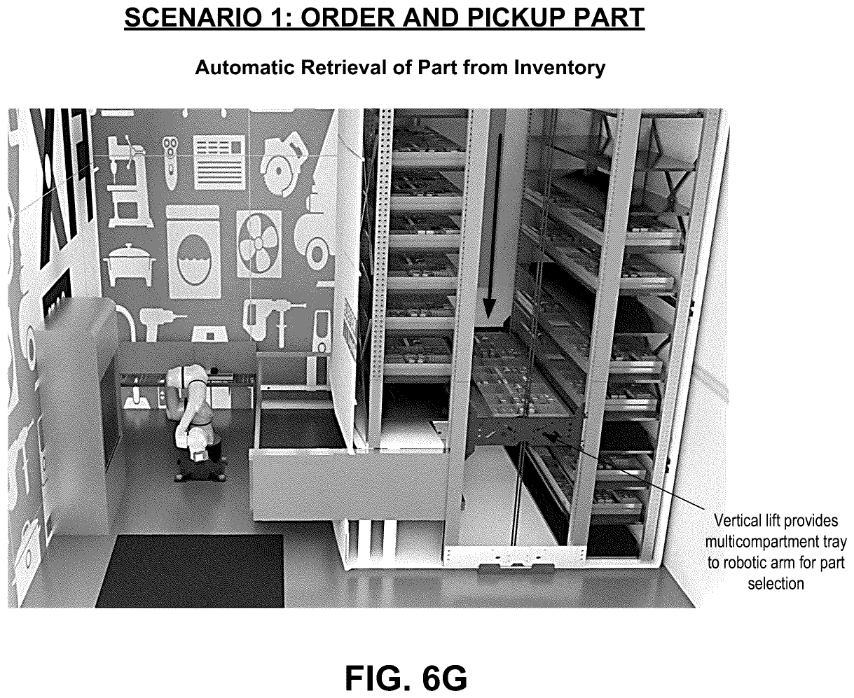

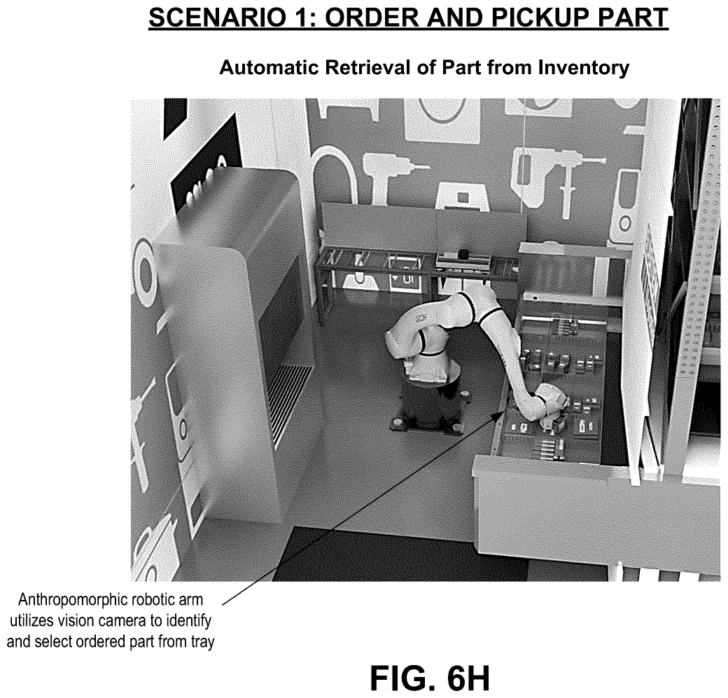

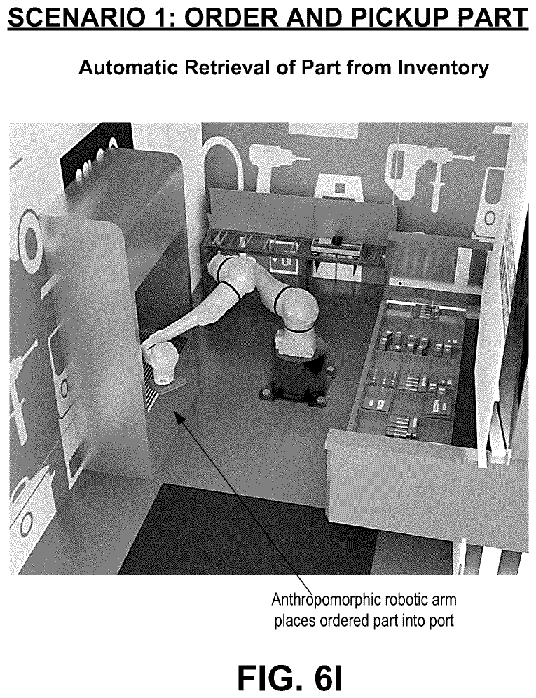

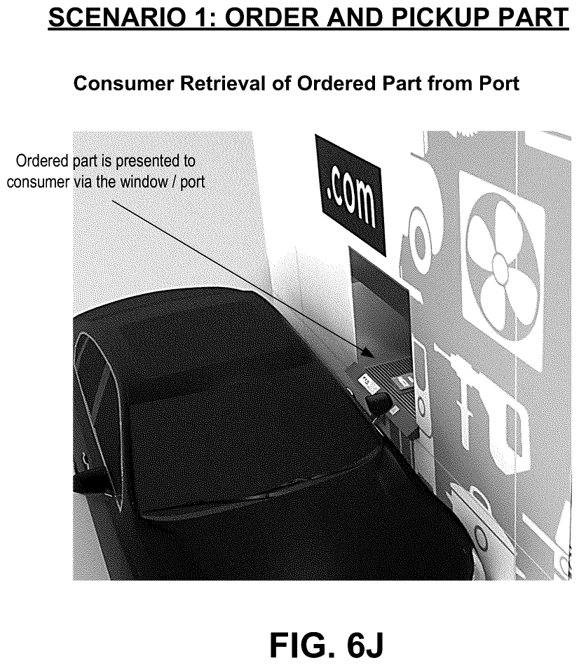

FIGS. 6A-6J illustrate a first scenario consisting of a consumer ordering a part via interaction with the asset management platform 12 and subsequent vending of that part via from the autonomous vending kiosk.

FIG. 6A is a screenshot of an interface on a mobile device associated with the asset management services provided by the asset management platform of the present disclosure. As shown, the consumer has already selected a specific part to purchase and is further provided with a location of the nearest kiosk that has that particular part in stock and available for immediate pickup. Accordingly, in the event that the consumer selects the option for picking up the part at the kiosk, and further completes the purchase transaction, the consumer is then provided with a unique machine-readable code (i.e., a QR code) that they will subsequently use at the kiosk to show proof of purchase.

FIG. 6B depicts the consumer arriving at the kiosk and interacting with a self-service vending port of the kiosk. FIG. 6C is a screenshot of QR code that the consumer was provided upon purchasing a part, wherein such QR code is presented to the user interface at the vending port of the kiosk to initiate a vending transaction.

Upon scanning the QR code, a determination is made as to whether the QR code is valid (i.e., whether it matches with a QR code generated and sent to the consumer). In other words, the kiosk may generally include a computing system configured to communicate and exchange data with the asset management platform. As such, upon scanning the QR code presented by the consumer, the QR code data is processed to determine whether there is a positive correlation with a reference QR, thereby indicating that the presented QR code is valid. In turn, the kiosk computing system is configured to then communicate with various internal components tasked with accessing and subsequently vending the purchased part associated with the QR code to the consumer.

FIGS. 6D and 6E are perspective views of an interior portion of the kiosk, illustrating various internal components for carrying out automated vending, return, and replenishment functions without requiring human intervention.

As shown, the kiosk may include a tower structure within the enclosure that is configured to hold a plurality of parts upon a plurality of vertically arranged shelves, such that the inventory is provided in a stacked arrangement. Each shelf may support one or more compartmentalized trays, for example, in which specific parts are placed within specific compartments of a given tray and such organization is saved in a database. In other words, each part, each compartment, and each tray, as well as each shelf of the tower, may have a unique identification code associated therewith such that a given part has a defined compartment within a defined tray, to be placed upon a defined shelf. As such, any given part within the tower has a known exact location based on an association of the unique identification codes.

The tower essentially encloses a mechanized storage and retrieval assembly configured to access trays within the tower for vending and replenishment functions. For example, the kiosk may include a vertical lift module, a vertical carousel module, or the like for providing automated storage and retrieval of goods within the tower. Accordingly, the storage and retrieval assembly may allow for access to any given good based on the known location thereof. For example, upon analyzing the QR code, the specific good is identified, which, in turn, causes mechanized storage and retrieval assembly obtain a tray upon which a specific good is placed.

In the illustrated embodiment, a vertical lifting machine is shown. As such, upon analyzing the QR code, the specific part is identified, which, in turn, causes the vertical lift module to travel to a given shelf and obtain the tray upon which the specific part is placed. For example, in one embodiment, the kiosk may incorporate a vertical lift module offered by Modula (Franklin, Ohio). However, it should be noted that any type of vertical lifting machine, or any automated storage and retrieval assembly may be used with the system of the present invention. FIGS. 6F and 6G depict automatic retrieval, via a vertical lift module, of a tray from the inventory tower that contains a purchased part to be vended to the consumer.

The kiosk further comprises an anthropomorphic robotic arm configured to pick the specific part from the tray and present the part to the consumer via the drive-thru port. In particular, the anthropomorphic robotic arm utilizes vision-based grasping techniques to identify the part, grasp the part (without causing damage to the part), and position the part at the port, allowing for the consumer to receive the part and complete the transaction. FIGS. 6H and 6I depict picking of the purchased part from the retrieved tray via an anthropomorphic robotic arm. For example, in one embodiment, the kiosk may incorporate an anthropomorphic robotic arm offered by Yaskawa Electric Corporation (Japan) and the various robotic control hardware/software, as well as vision hardware/software, may be provided by Mujin Corp. (Japan). FIG. 6J depicts presentation of the purchased part to the consumer via the self-service vending port of the kiosk.

In the event that a consumer is returning a part, the kiosk is configured to operate generally in a similar manner as when a part is being vended to the consumer (i.e., when a part is ordered and being picked up). For example, the consumer may initiate the return of a repair part via the internet-based asset management platform. Again, the asset management platform is configured to identify one or more of plurality of vending kiosks with a given location relative to the consumer and further provide the consumer with the option of traveling to and returning the particular part a given kiosk. In the event that the consumer selects a particular kiosk, the consumer is provided with a unique machine-readable code (e.g., QR code) that they will subsequently use at the kiosk to show proof of return (the QR code will be associated with the return and thus will be tied to the particular part that is to be returned).

Again, upon scanning the QR code, a determination is made as to whether the QR code is valid (i.e., whether it matches with a QR code generated and sent to the consumer). Upon establishing that the QR code is valid, the kiosk computing system is configured to then communicate with various internal components tasked with accepting the returned part and either placing the returned part back into the internal inventory of the kiosk or placing the returned part into a separate container (i.e., a tote or the like) to be subsequently retrieved and transported to a distribution center or the like. In particular, upon scanning the QR code, the outer closure will open (while the inner closure remains closed) thereby prompting the consumer to place the returned part within the space defined between the inner and outer closures if the port. The kiosk computing system will recognize that a part has been placed within the port, and will thus cause the outer closure to close and the inner closure to open. Accordingly, based on the data associated with the scanned QR code, the internal components will automatically go into action. In particular, the anthropomorphic robotic arm will retrieve the part and, in the event that the returned part is to be restocked in the inventory, the vertical lift module will automatically retrieve a tray to which the returned part is to be placed (via the robotic arm).

It should be noted that the port generally includes at least a two closures, including an outer closure and in inner closure, each of which is configured to move between fully opened and fully closed positions. For example, the default position of both the outer closure and the inner closure is in a closed position (see FIG. 6B). Accordingly, upon initiating an order pickup transaction (in which a part is being vended to a consumer), the outer and inner closures remain closed until the specific part has been retrieved by the internal mechanism within the kiosk. Upon the robotic arm picking the specific part from the retrieved tray, the inner closure may open while the outer closure remains closed (see FIG. 6I), which exposes a space defined between the outer and inner closures and into which the robotic arm can place the part. Upon placing the part within that space, the inner closure closes, thereby sealing off the interior of the kiosk and the outer closure opens, thereby presenting the part to the consumer (see FIG. 6J).

In addition to vending parts and accepting returned parts, the kiosk of the present invention is configured to automatically replenish inventory in an autonomous manner. More specifically, the kiosk is configured to essentially restock the inventory in a fully automated manner and without requiring human intervention. For example, the specific inventory of any given kiosk can be managed by the asset management platform. It may be determined at any given time that certain parts need to be replenished (i.e., the number of available parts is low in a given kiosk's inventory tower). As such, parts can be delivered to the kiosk via conventional means, such as by way of a vehicle. The driver of the vehicle need only interact with the drive-thru port interface (i.e., present a QR code associated with the replenishing parts) and then provide such parts to the kiosk. The parts may be provided in a large container, such as a tote or the like. Upon placing the tote with to port, the internal components of the kiosk take over, in that the robotic arm is configured to pick parts from the tote and place them into assigned compartments of trays that are placed onto the associated shelves of the tower via the vertical lift module.

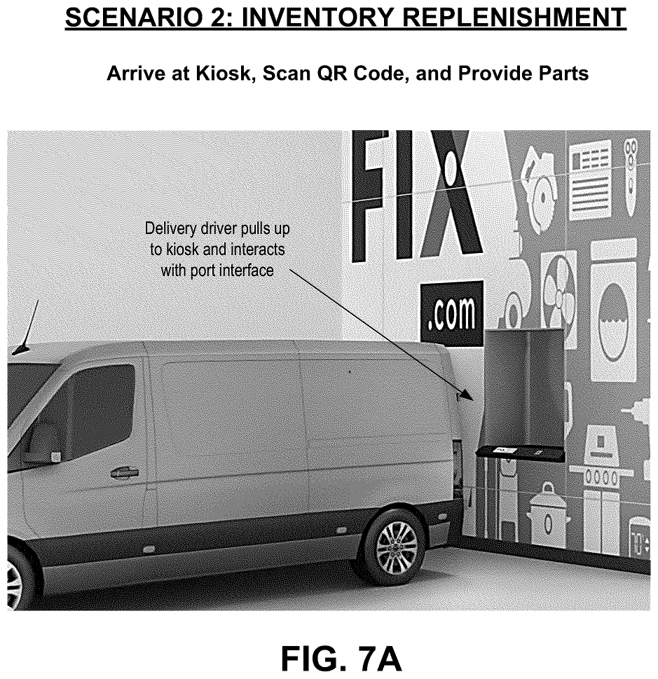

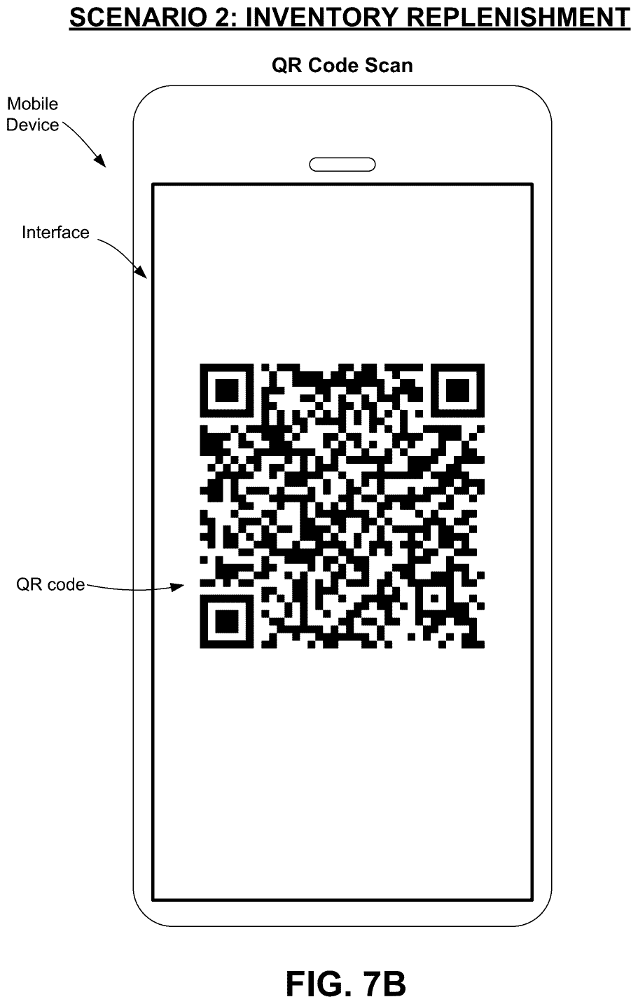

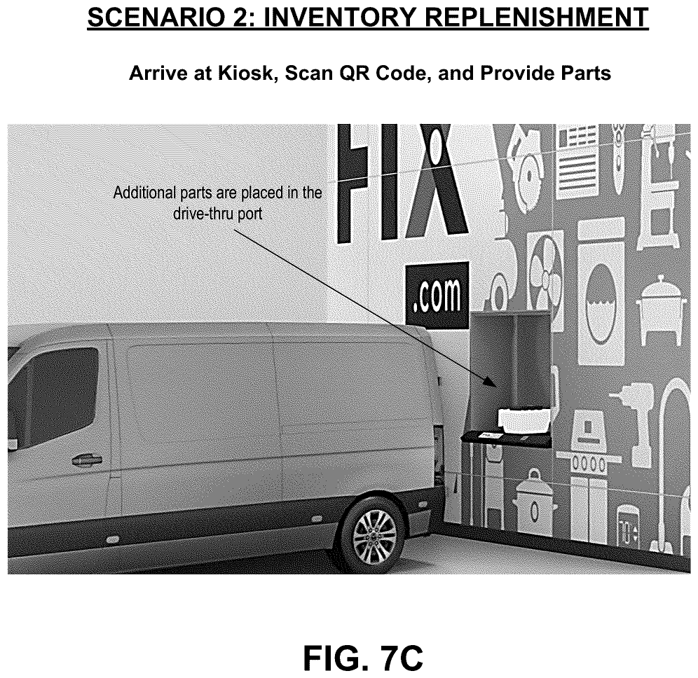

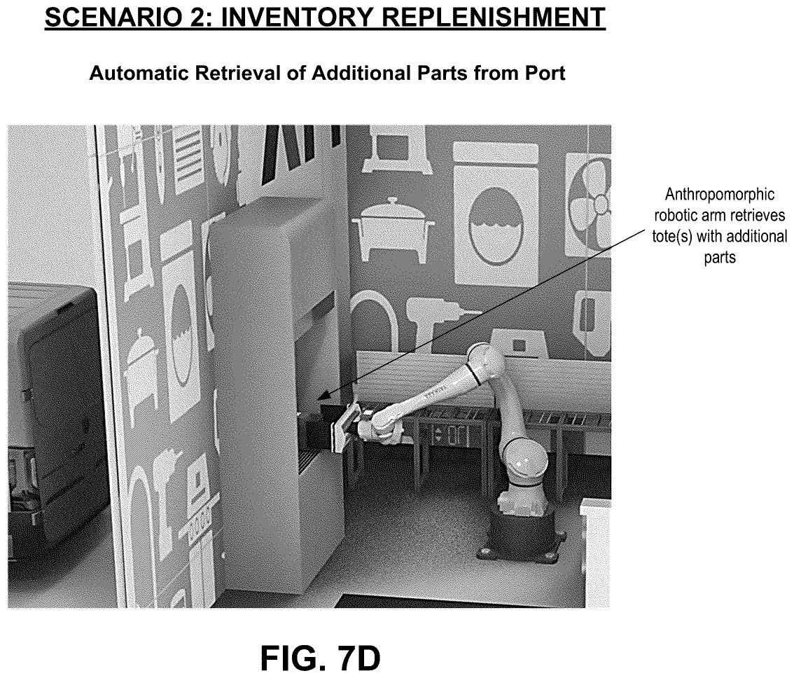

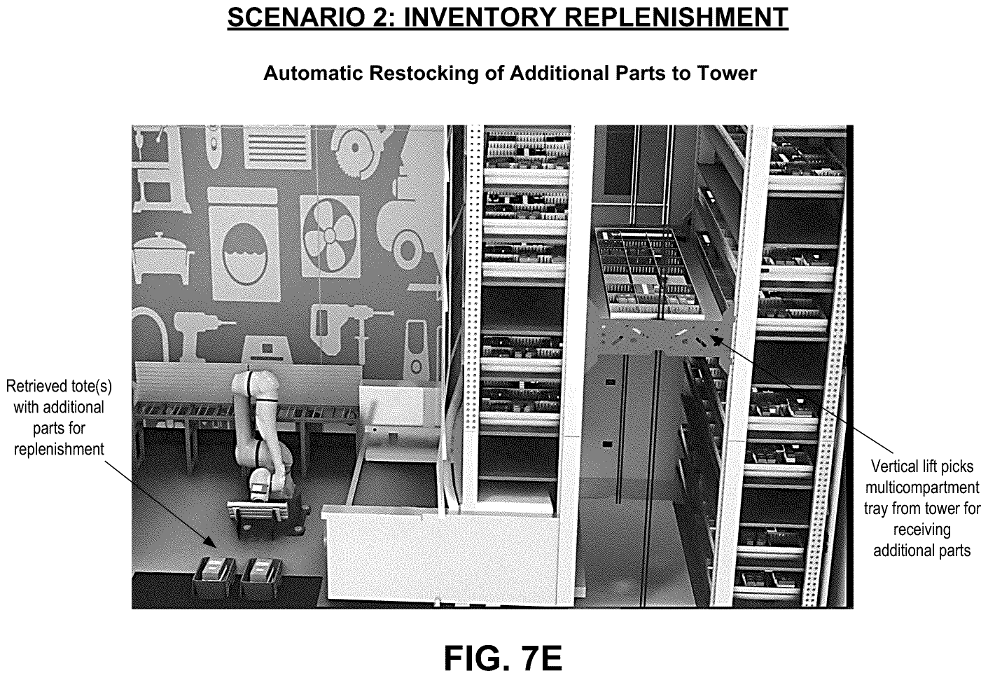

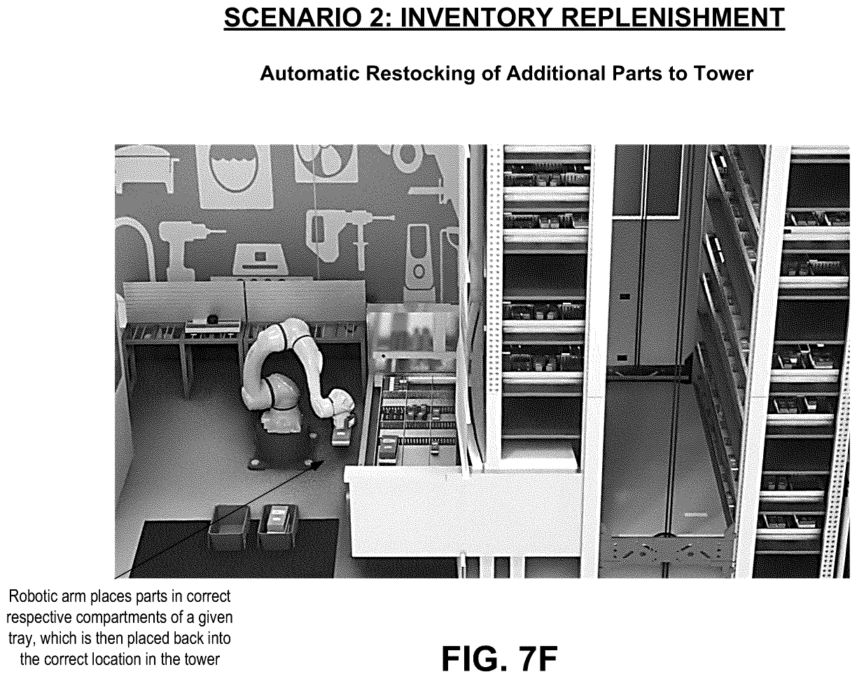

FIGS. 7A-7F illustrate a second scenario consisting of replenishing inventory of the autonomous vending kiosk. FIG. 7A depicts a delivery driver arriving at the kiosk and interacting with a self-service port of the kiosk. FIG. 7B is a screenshot of QR code that the delivery driver can present to the user interface at the port of the kiosk to initiate a replenishment transaction. FIG. 7C depicts delivery of parts (i.e., placement of the parts within the port of the kiosk) that are to be subsequently stocked in the kiosk's inventory. FIG. 7D depicts automatic retrieval of the delivered parts from the port via the anthropomorphic robotic arm. FIGS. 7E and 7F depict automatic restocking of the delivered parts to the inventory via actions carried out by the anthropomorphic robotic arm and vertical lifting module.

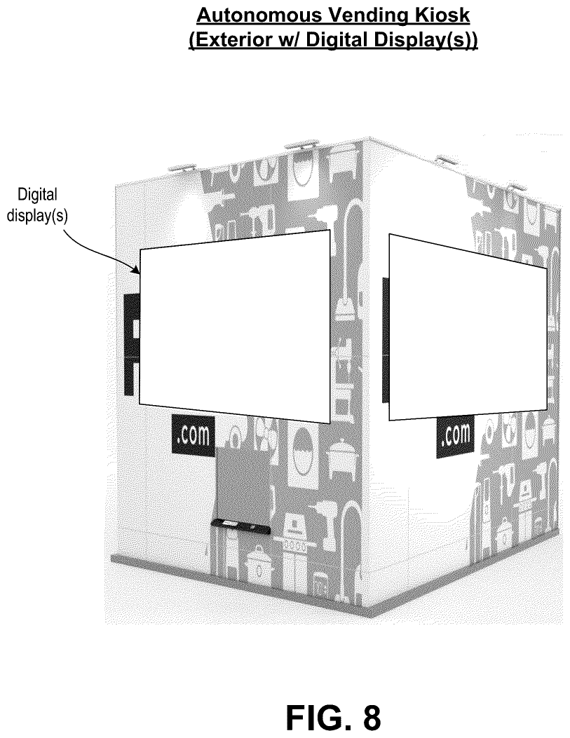

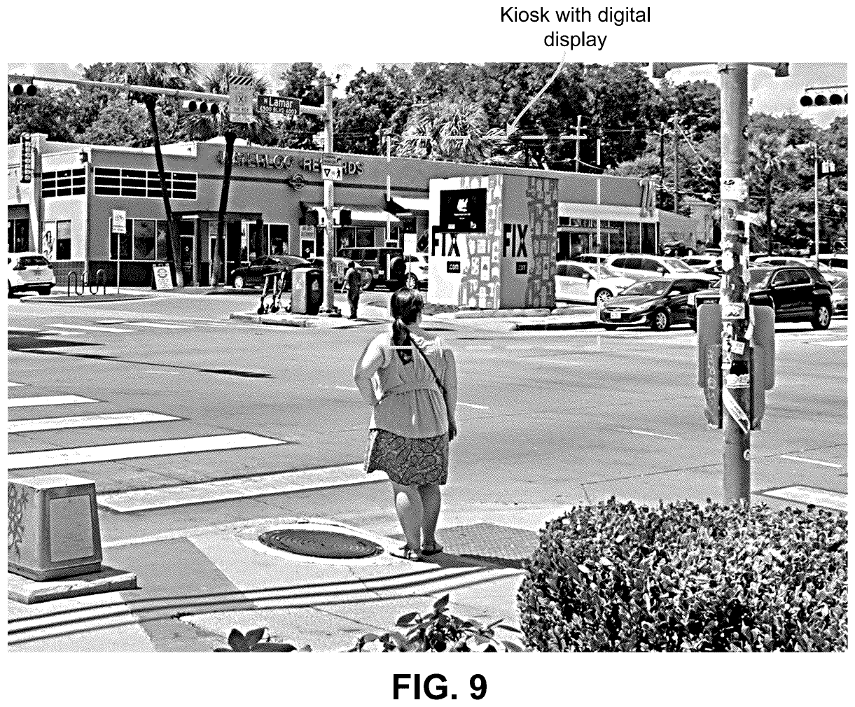

It should further be noted that, in addition to providing automated vending and storage services, the network of kiosks may also be utilized to provide advertising services. In particular, the exterior of a given kiosk may include one or more digital displays for providing advertisements to the general public. For example, FIG. 8 is a perspective view of an exterior of a kiosk consistent with the present disclosure including digital displays. FIG. 9 is an image depicting placement of a kiosk within retail location and having a digital display for advertisements.

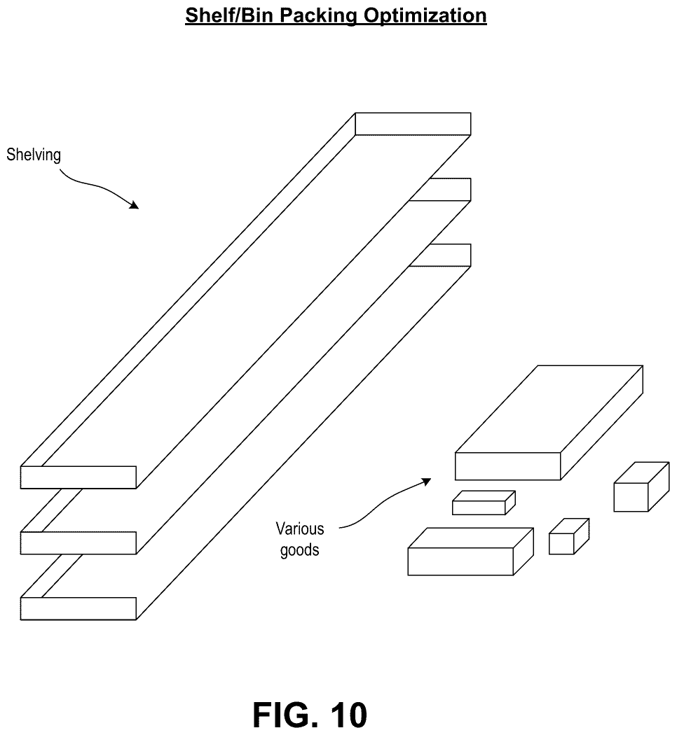

It should be noted that the goods distribution system is further configured to provide tray and/or shelf packing optimization. In particular, the system is able to utilize packing algorithms to identify optimal packing arrangements for a given tray and/or shelf. For example, in one embodiment, any given tray and/or shelf may be analyzed and subsequently packed with goods in an optimal arrangement so as to fully utilize the capacity of the given tray and/or shelf as well as provide the most highly requested, purchased, or otherwise sought after goods. For example, FIG. 10 is a perspective view of shelving and various goods to be arranged on such shelving to achieve optimal packing arrangements.

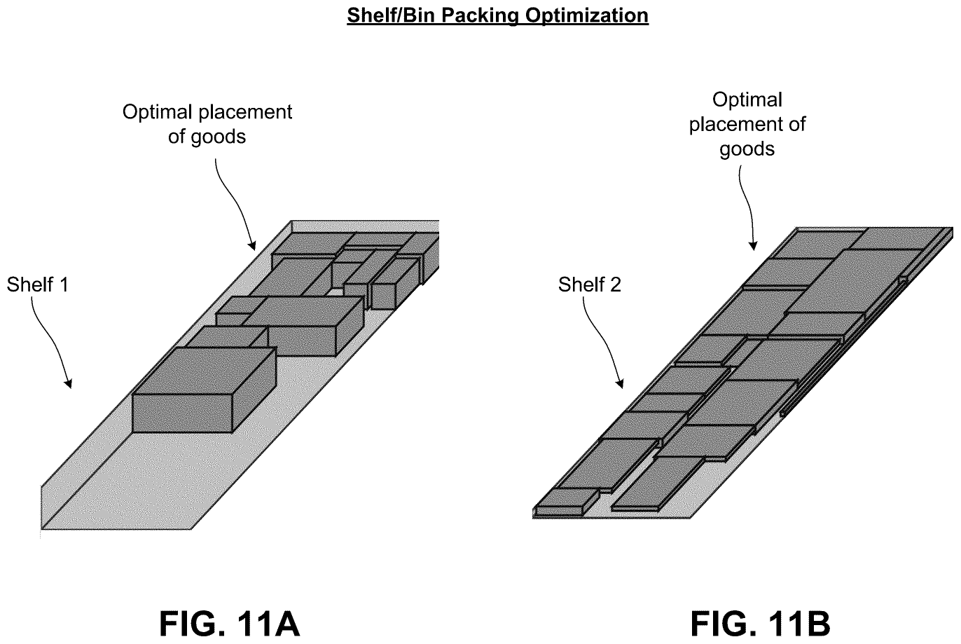

The optimal packing can be accomplished based on an analysis of a given tray and/or shelf include utilizing the known volume of a given tray or shelf, as well as the known volume and/or packaging dimensions of goods, and arranging placement of a set of goods into the tray or shelf in such a manner that nearly all usable volume of a given tray or shelf is utilized. FIGS. 11A and 11B illustrate exemplary embodiments of shelves packed with various goods in an optimal arrangement based on packing algorithms.

As previously described, the purpose of determining optimal packing of a given tray or shelf is to allow for full realization of the storage capacity of a given kiosk, both in terms of SKU coverage and depth, thereby making the kiosks of the present invention much more practical and useful for consumers. In this instance, a vertical lifting module may not be necessary for the storing and retrieving of parts on the trays and/or shelves. Rather, the system may simply utilize vision-based storage and retrieval, in which images the interior of the tower of shelves and placement of parts thereon may be used and relied upon to allow for a robotic arm to utilize its vision capabilities to sort trays and/or shelving and find and select the specific part of interest. In addition to fining the correct part(s), the robotic arm can further place the trays and/or shelving in the appropriate location(s).

Accordingly, the unmanned fully autonomous vending kiosks of the present invention provide numerous advantages over current vending options. In particular, the kiosks are configured to cooperatively function with an internet-based asset management service that allows consumers browse and purchase various parts and further initiate a pickup or return of a purchased part via a given one of the network of kiosks. Each kiosk is configured to vend purchased parts to consumers, accept and process returned parts from consumers, and further replenish parts stored therein in fully autonomous manner and without requiring human intervention.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A goods distribution system comprising a plurality of unmanned fully autonomous kiosks, wherein each kiosk is configured to vend goods to users, accept return of goods from users and automatically restock returned goods, and accept and automatically replenish goods to be vended to users.

2. The system of claim 1, wherein each kiosk is a standalone structure comprising an enclosure housing a plurality of components within.

3. The system of claim 2, wherein each kiosk comprises a window or port which a user interacts to pick up a purchased good, return a good, and/or deliver goods for replenishing inventory stored within the kiosk.

4. The system of claim 3, wherein the window or port comprises an interactive user interface which a user can interact to initiate a transaction with the kiosk including at least one of vending of a good, returning of a good, and/or replenishing of goods.

5. The system of claim 4, wherein the user interface comprises a scanning module for scanning a machine readable code presented by the user to initiate the transaction.

6. The system of claim 5, wherein the transaction is initiated upon establishment of a positive correlation of the scanned code with a reference code.

7. The system of claim 2, wherein each kiosk comprises a tower structure configured to hold a plurality of goods upon a plurality of organized shelves.

8. The system of claim 7, wherein the tower structure comprises a plurality of vertically arranged shelves.

9. The system of claim 8, wherein inventory is provided within respective trays provided on the shelves in a substantially vertically stacked arrangement.

10. The system of claim 9, wherein at least some of the trays are compartmentalized trays in which specific goods are placed within specific compartments of a given tray.

11. The system of claim 9, wherein a location of any specific good within the tower structure is monitored and tracked based on unique identification codes associated with each good, each tray, and each tower.

12. The system of claim 7, wherein each kiosk comprises a mechanized storage and retrieval assembly configured to trays within the tower structure for a given transaction.

13. The system of claim 12, wherein the mechanized storage and retrieval assembly comprises at least one of a vertical lift module, a vertical carousel module, or the like for providing automated storage and retrieval of goods within the tower structure

14. The system of claim 7, wherein each kiosk comprises an anthropomorphic robotic arm configured to handle one or more goods for a given transaction based, at least in part, on vision-based programming.

15. The system of claim 14, wherein the anthropomorphic robotic arm is configured to identify a given good, grasp the good, and position the good for vending of the good to a user, returning of the good from the user, or a replenishing of inventory with the good.

16. The system of claim 1, wherein each of the plurality of unmanned fully autonomous kiosks is configured to communicate and transmit data with an internet-based asset management platform.

17. The system of claim 16, wherein the data transmitted between each of the plurality of unmanned fully autonomous kiosks and the asset management platform comprises at least one of: purchase data associated with a user purchase of a good; return data associated with a user return of a good; replenishment data associated with replenishment of one or more goods in a given kiosk inventory.

18. The system of claim 17, wherein the purchase data and return data are associated with a user's purchase request and return request, respectively, of an associated good based on user interaction with an interface on a user's computing device provided via the asset management platform.

19. The system of claim 18, wherein the purchase data and return data each comprise at least the identity of the good and an associated machine readable code tied to the transaction and to be used for subsequent authentication of the transaction upon user interaction with a given kiosk.

20. The system of claim 17, wherein the data transmitted between each of the plurality of unmanned fully autonomous kiosks and the asset management platform further comprises inventory data associated with a current inventory of goods present within each kiosk.
